(19) United States
(12) Patent Application Publication
(10) Pub. No.: US 2026/0236982 A1
(43) Pub. Date: Aug. 13, 2026

(54) Threshold-Driven Online Auction System and Method

(71) Applicant: Patrick Michael Flynn, Saugus, MA (US)

(72) Inventor: Patrick Michael Flynn, Saugus, MA (US)

(21) Appl. No.: 18/898,025

(22) Filed: Sep. 26, 2024

Related U.S. Application Data
(60) Provisional application No. 63/586,067, filed on Sep. 28, 2023.

(51) Int. Cl. G06Q 30/08; G06Q 30/0601

(52) U.S. Cl. CPC G06Q 30/08; G06Q 30/0641

(57) ABSTRACT

The invention relates to a “Threshold-driven online auction System and Method”, where auctions are dynamically triggered based on real-time user interest. Sellers list items on a marketplace, and potential buyers express interest by “Liking” or “Following” the listing. These interactions are tracked by a demand meter, which graphically displays the progress toward a predefined demand goal. Once the demand goal is reached, the system automatically initiates the auction, allowing for shorter and more efficient auction durations compared to conventional online auction systems. The system also includes features such as customizable demand goals, and real-time notifications for interested users, enhancing both user engagement and seller control. This approach reduces idle auction times, optimizes auction durations, and ensures that auctions go live only when sufficient interest is established.

### RELATED CASES

This application claims the benefit of U.S. Provisional Application No. 63/586,067, filed on 28 Sep. 2023, the contents of which are all incorporated by reference.

### FIELD

The present invention relates generally to online auction systems, and more specifically to a system and method for initiating auctions based on user interest/demand levels.

### BACKGROUND OF THE INVENTION

Traditional online auction platforms, such as eBay, allow sellers to list goods for a predetermined period, during which potential buyers can place bids. These auctions typically run for extended durations, regardless of the level of demand or interest in the item. While this model works well for some types of items, it can result in inefficient use of time and resources, particularly for items with varying demand and items that need to be sold in less than 24 hours.

One significant drawback of conventional online auction systems is the fixed auction period, which does not account for real-time user interest or demand for the listed item. Sellers are often forced to wait for the auction's completion, even when a sufficient level of buyer interest has already been established. This model can be frustrating for both sellers and buyers, as auctions may take longer than necessary to complete, delaying transactions and reducing overall platform efficiency.

There is a need for an improved system that allows for shortened auction durations based on real-time demand, allowing auctions to go live for bidding once a predetermined level of interest is reached. The present invention addresses this need by introducing a demand-driven auction system that uses a threshold-based model to trigger the start of an auction, reducing unnecessary auction duration and improving the efficiency of the buying and selling process.

### SUMMARY

The present invention provides a Threshold-Driven Online Auction System & Method that dynamically triggers the start of an auction based on user interest, as measured by a demand threshold. The system enables sellers to list items on an online marketplace, where potential buyers can express interest by “Liking” or “Following” the listing by engaging/clicking on a corresponding link, icon, or button on the listing. Each “Like” or “Follow” contributes to a Demand Meter/Graphical Display, which visually represents the current level of interest relative to a predefined Demand Goal. “Liking” or “Following” can be represented in various ways, included but not limited to clicking on icons such as “Hearts” or “Thumbs”, or verbal representations of the words “Like” or “Follow”, and other icons/words with similar meanings.

Once the Demand Goal is met, the system automatically transitions the item to live auction status, enabling real-time bidding. This allows the auction to begin only when sufficient buyer interest has been established, significantly reducing the overall auction duration compared to conventional systems. The Demand Meter ensures transparency for both sellers and potential buyers, giving them real-time updates on the item's popularity and progress toward the auction threshold.

In one embodiment, the system includes a graphical user interface (GUI) that displays the Demand Meter/Graph alongside the item listing. The system also features automatic notifications for interested buyers when the auction goes live, ensuring that potential bidders are aware of the transition. Additionally, the system includes tools for sellers to set the Demand Goal and customize the auction parameters, such as starting price, and duration.

This method increases the efficiency of online auctions by aligning auction timing with market demand and user interest. The invention can be applied to a wide variety of products, goods, and services, improving the experience for both buyers and sellers.

The Threshold-Driven Online Auction System & Method introduces several key innovations that distinguish it from traditional online auction platforms. These key aspects include:

A unique feature of this system is the introduction of a Demand Threshold, which dynamically governs when an auction is triggered to start based on real-time user interest. Potential buyers can show interest by “Liking” the listing, and each “Like” contributes to a Demand Meter that graphically tracks the progress toward a predefined Demand Goal. This ensures that auctions only commence when there is sufficient market demand, improving the efficiency of the auction process and eliminating the need for unnecessarily long auction durations.

The invention utilizes a Demand Meter to visually represent the accumulation of user interest. The meter fills proportionally as more users “Like” the item, providing both sellers and buyers with a transparent, real-time view of the item's popularity. This visual feedback encourages further engagement and helps users gauge the likelihood of when the auction listing will go-live for bidding.

Once the Demand Goal is met (i.e., the number of “Likes” reaches or exceeds the seller-defined threshold), the system automatically transitions the item to live auction status. This automation removes the need for manual intervention by the seller, streamlining the process and ensuring that auctions are launched at the optimal moment based on user interest.

By waiting for the Demand Goal to be reached before triggering the auction, the system enables auctions to have shorter durations. This is particularly beneficial for items with high demand, as the system avoids lengthy, unnecessary waiting periods that are typical of conventional online auction systems.

The system encourages active user engagement by notifying users who have “Liked” an item when the auction goes live. This notification module ensures that interested buyers are alerted in real time, giving them the opportunity to participate in the bidding process without having to continuously monitor the listing.

Sellers have the flexibility to set the Demand Goal based on their preferences and can adjust the goal prior to the auction being triggered to start. This customization feature allows sellers to tailor the auction to their market's dynamics and expectations, further enhancing the platform's adaptability.

### BRIEF DESCRIPTION OF THE DRAWINGS

FIGS. 1-3 are example diagrammatic views of the Threshold-Driven Online Auction System & Method according to one or more example implementations of the disclosure; and

FIG. 4 is an example flowchart of the Threshold-Driven Online Auction process according to one or more example implementations of the disclosure.

### DETAILED DESCRIPTION

The present invention relates to a system and method for conducting online auctions, specifically a Threshold-Driven Online Auction System & Method, which incorporates a demand-driven approach to initiate the auction process based on real-time user interaction. The invention addresses common inefficiencies in conventional online auctions, such as unnecessarily long auction durations and limited visibility into user interest. By leveraging user interactions to trigger auctions, the invention optimizes the auction process and enhances user engagement.

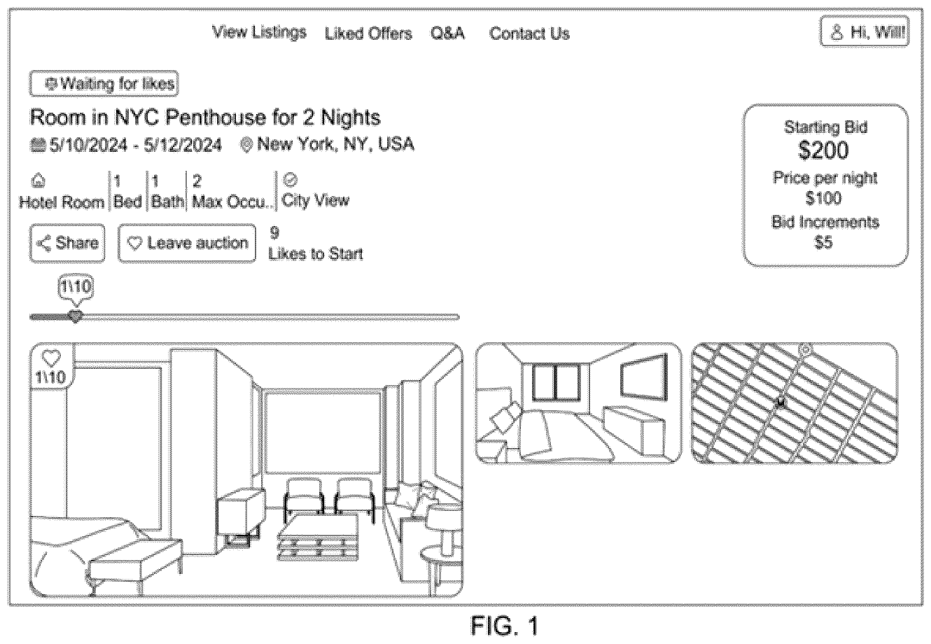

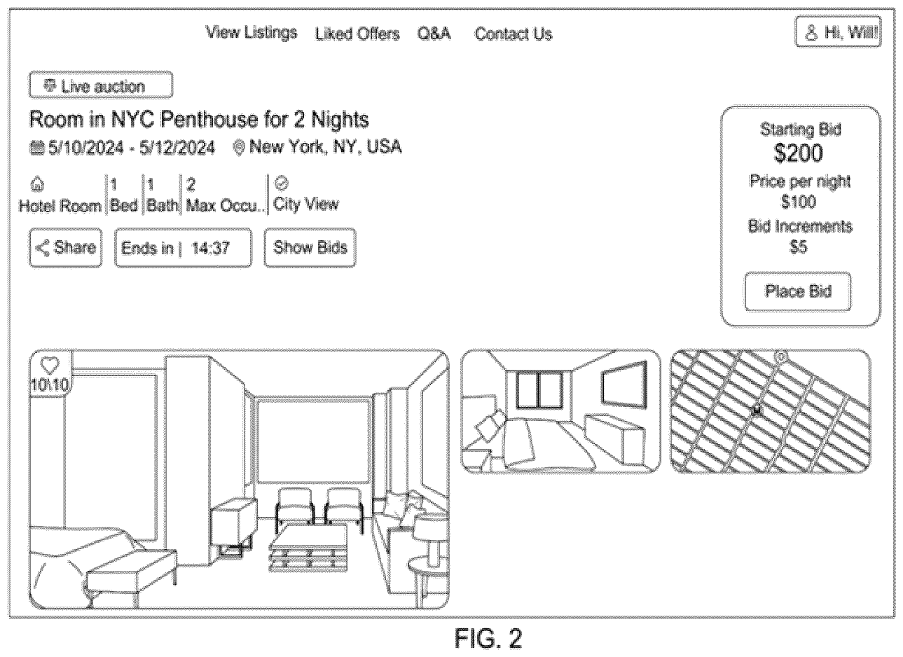

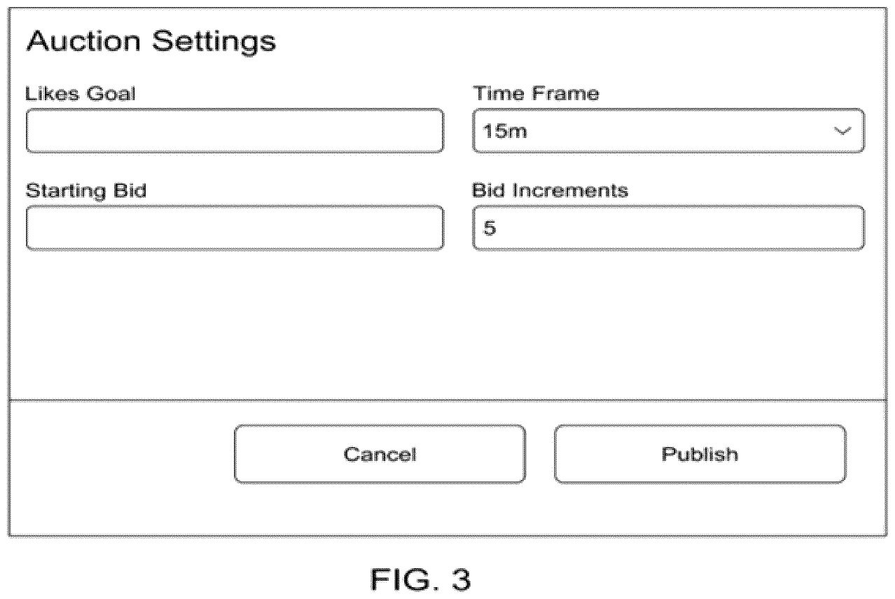

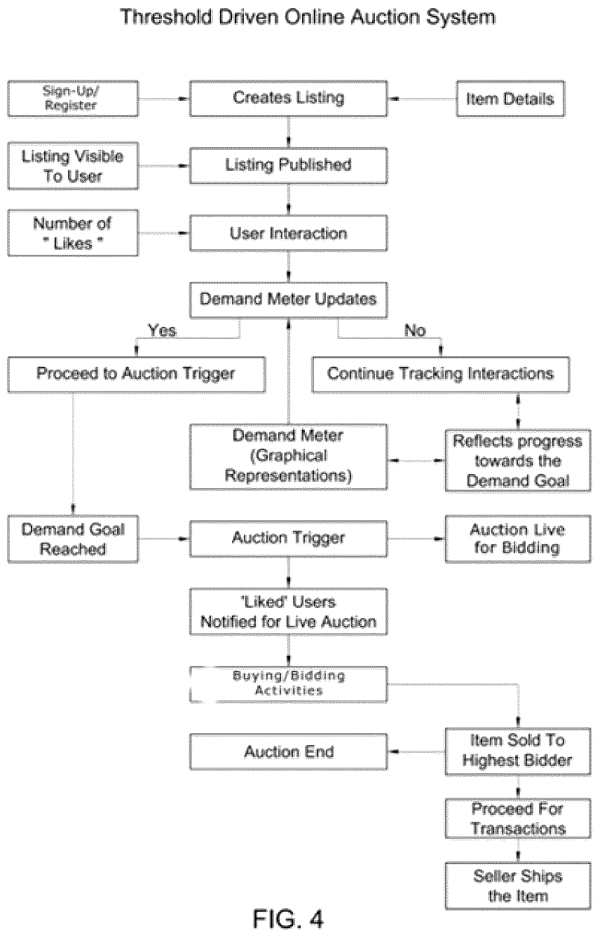

The Threshold-Driven Online Auction System comprises several key components:
A Demand Threshold Module for tracking user interest (FIG. 1).
A Demand Meter to graphically represent user interaction and progress toward the demand goal (FIG. 1).
An Auction Trigger Mechanism that automatically initiates an auction when the demand threshold is reached (FIG. 2).
A Notification System that alerts users when auctions go live.
A Seller Dashboard allowing sellers to set and monitor the demand threshold and auction progress (FIG. 3).

The system may be implemented on a variety of platforms, including but not limited to websites, mobile applications, and integrated marketplace systems.

In contrast to conventional online auction systems that rely on preset durations (e.g., 7-day or 10-day auctions), the present invention introduces a dynamic mechanism in which the auction start time is governed by real-time user interaction. Specifically, each listing is assigned a Demand Goal, which represents the number of user interactions (e.g., “Likes”) required for the auction to begin.

Each time a potential bidder or interested user clicks a “Like” button or similar button associated with showing interest in a listing, the system records this interaction. The total number of “Likes” is then tracked and compared to the pre-set Demand Goal. Once the Demand Goal is met or exceeded, the auction is automatically triggered and transitioned into a live bidding phase.

This mechanism eliminates unnecessary delays, allowing auctions to begin only when a sufficient level of interest is demonstrated by the user base, thus reducing auction duration and improving efficiency.

The system provides a graphical representation of user interest through a Demand Meter. The Demand Meter visually displays the progress toward the Demand Goal, updating in real-time as users “Like” the listing. Various visual representations for the Demand Meter can be implemented, including but not limited to:
A horizontal or vertical progress bar that fills proportionally as the number of “Likes” increases.
A circular meter that fills radially, similar to a pie chart or clock.
A thermometer-style gauge that visually rises as more Likes are collected.
A meter where an icon or icons are filled based on the percentage of the goal achieved.
A numerical meter showing the amount of demand required to reach the goal.

In each case, the Demand Meter is designed to provide immediate feedback to users about the level of interest in the item, encouraging further engagement. For example, if a user sees that the Demand Meter is nearly full, they may be more inclined to place a “Like” to help trigger the auction.

Once the Demand Meter indicates that the Demand Goal has been reached, the system transitions the listing from its pre-auction state to an active auction. This transition is performed automatically by the system without requiring manual intervention from the seller. In the live auction phase, users can place bids on the item.

Sellers may configure various auction parameters, such as the starting bid, bid increments, and auction duration prior to the auction going live. The Auction Trigger Mechanism ensures that the auction only begins when there is sufficient market interest, as defined by the number of “Likes” received.

In certain embodiments, the system may also support tiered demand goals, where multiple thresholds must be met to trigger different stages of the auction, such as a pre-bidding phase followed by the final live auction.

User engagement is a critical component of the Threshold-Driven Online Auction System. Once a user expresses interest in a listing by clicking the “Like” button, they are added to a list of interested bidders. The system may also include a Notification System that sends alerts to users when the auction is about to begin or when certain milestones in the demand meter are reached (e.g., when the meter hits 50%, 75%, or is full).

This notification system encourages active participation from users, ensuring they are informed and ready to participate once the auction is live. Notifications can be delivered via email, SMS, push notifications, or directly within the marketplace interface.

Sellers have control over the settings of each auction via a Seller Dashboard. The dashboard allows sellers to:
Set the Demand Goal, which defines how many “Likes” are required to trigger the auction.
Monitor the Demand Meter in real-time, providing feedback on how much interest the listing is generating.
Adjust auction parameters such as starting price, auction duration, and bid increments.
Access analytics regarding user interactions and bidding history for auctions.

The ability to customize the demand goal and monitor auction performance in real-time provides sellers with a powerful tool to optimize their listings and maximize engagement.

In certain embodiments, the system may allow for dynamic pricing or auction adjustments based on user interactions. For example, if the demand threshold is not met within a predetermined time frame, the system could automatically reduce the starting bid price or apply a discount to the item. Conversely, if the demand meter fills quickly, the system could shorten the auction duration or increase the starting bid price.

These dynamic adjustments ensure that the auction process remains fluid and responsive to user behavior, optimizing the likelihood of a successful auction.

To maintain the integrity of the system and prevent fraudulent activity, the system may include various security features. These may include user verification mechanisms to ensure that “Likes” are coming from legitimate users, as well as fraud detection algorithms to identify suspicious patterns of activity. By incorporating these safeguards, the system ensures that auctions are conducted fairly and transparently.

1.-20. (canceled)

21. A threshold-driven online auction system, comprising:
a server configured to host an online marketplace, the server being operably connected to a network;
a user interface accessible via the network, the user interface enabling a seller to list an item for auction and a plurality of users to express interest in the item by selecting a “Like” option;
a demand meter displayed within the user interface, the demand meter graphically representing a current level of user interest in the listed item based on the number of “Likes” received;
a demand goal, set by the seller, representing a predefined level of user interest required to trigger the auction;
a threshold module configured to:
monitor the number of “Likes” received for the item,
update the demand meter in real time based on the number of “Likes,” and
automatically transition the item from a listing to a live auction when the number of “Likes” reaches the demand goal; and
a bidding module configured to allow users to place bids on the item once the auction is live.

22. The system of claim 21, further comprising a notification module configured to automatically notify users who have “Liked” the item when the auction goes live.

23. The system of claim 21, wherein the demand meter fills proportionally to the number of “Likes” relative to the demand goal.

24. The system of claim 21, wherein the seller is enabled to adjust the demand goal before the live auction is triggered.

25. The system of claim 21, wherein the seller can purchase tokens or credits to increase the demand threshold.

26. The system of claim 21, wherein the user interface further comprises a countdown timer.

27. The system of claim 21, wherein the demand meter comprises a horizontal bar that fills as the number of “Likes” received increases.

28. The system of claim 21, wherein the demand meter comprises a circular meter that fills as the demand goal is approached.

29. The system of claim 21, wherein the demand meter comprises a gauge that fills as the number of “Likes” increases.

30. The system of claim 21, wherein the demand meter comprises an icon or icons that fill as the demand goal is reached.

31. The system of claim 21, wherein the demand meter comprises a dial or speedometer-style gauge that moves based on the number of “Likes” received.

32. The system of claim 21, wherein the demand meter comprises customizable visual themes, allowing the user to modify the appearance of the demand meter.

33. The system of claim 21, wherein the demand goal is dynamically set based on the category of the item or historical user engagement data.

34. The system of claim 21, wherein the auction system includes multiple demand thresholds that trigger different stages of the auction.

35. The system of claim 21, further comprising an integration module that allows users to share the auction listing and demand meter progress on external social media platforms.

36. The system of claim 21, further comprising a demand analytics module that predicts future demand based on current user interactions and historical data.

37. The system of claim 21, further comprising an auction boosting module allowing sellers to pay to accelerate the rate at which the demand meter fills based on promotional activity.

38. The system of claim 21, further comprising a geo-targeting module that allows the seller to limit the visibility of the auction to users in a specific geographic region.

39. The system of claim 21, further comprising a seller analytics dashboard that provides real-time data on user engagement, demand meter progress, and bidding activity.

40. The system of claim 21, wherein an Al-powered module dynamically adjusts auction parameters such as demand goal, starting bid and auction duration based on the rate of user interest accumulation and historical auction performance data.
